(19) United States
(12) Patent Application Publication
(10) Pub. No.: US 2016/0345719 A1
(43) Pub. Date: Dec. 1, 2016

(54) REPLACEMENT BRUSH HEAD FOR AN ELECTRIC TOOTHBRUSH

(71) Applicant: RANIR, LLC, Grand Rapids, MI (US)

(72) Inventor: Bryan J. Dishon, Grand Rapids, MI (US)

(21) Appl. No.: 15/111,655

(22) PCT Filed: Jan. 23, 2015
(86) PCT No.: PCT/US2015/012586

§ 371 Date: Jul. 14, 2016

Related U.S. Application Data
(60) Provisional application No. 61/931,886, filed on Jan. 27, 2014.

(51) Int. Cl. A46B 7/04; A61C 17/34; A46B 9/04

(52) U.S. Cl. CPC A46B 7/046; A46B 9/04; A61C 17/3418

(57) ABSTRACT

A replacement head (10) for an electric toothbrush drive unit having a driveshaft that oscillates about a longitudinal axis. The replacement head (10) includes a bristle head (12), and a brush shaft (20). The brush shaft (10) cooperates with the drive shaft of the drive unit to produce angular movement of the bristle head at a reduced angle and torque to provide a comfortable and effective user experience.

### BACKGROUND OF THE INVENTION

The present invention is directed to electric toothbrushes, and, more particularly, to a replacement head that is attachable to an electric toothbrush drive unit.

Recognizing that toothbrush bristles require periodic replacement, manufacturers have designed replacement heads to fit onto separate drive units of electric toothbrushes. The drive units typically include a power source, switch and a drive shaft. The replacement heads typically can be removably attached to the drive units by threading or snap-fitting a portion of the replacement head onto a portion of the drive unit.

Replacement heads typically include an elongated neck with an internal brush shaft connected to a bristle bearing head. The brush shaft is arranged to transfer power from the drive unit and drive shaft to the brush head for moving the brush head in a desired manner. Many brush heads are configured to transfer rotational movement of the drive shaft about a longitudinal axis into rotational or oscillatory movement of the bristle head about an axis that is perpendicular to the longitudinal axis of the drive shaft. Other brush heads are configured to move the bristle head about the same longitudinal axis as the drive shaft, or about an axis that is parallel to the longitudinal axis of the drive shaft. Each type of brush head generally includes a motion conversion mechanism for transferring the motion of the drive shaft into a desired motion of the bristle head that is effective at cleaning teeth and comfortable for a user.

### SUMMARY OF THE INVENTION

The present invention provides a replacement brush head for an electric toothbrush with a motion conversion mechanism that provides an effective and user friendly bristle motion. In one embodiment, the motion conversion mechanism operates to move the bristle head about an axis that is generally parallel to the longitudinal axis of the drive shaft, while reducing the bristle travel angle and power—as compared to that of the drive shaft—to provide an effective and user friendly bristle motion.

In one embodiment, the replacement head includes a neck and a bristle head. The neck may be a generally hollow and may be fixed to a stationary portion of the drive unit. At least a portion of the bristle head may extend through the neck along a longitudinal axis that is aligned with the longitudinal axis of the drive shaft. A bristle base may be fixed to a distal end of the bristle head. The opposite end of the bristle head forms a brush shaft that receives the drive shaft.

In one embodiment, portions of the bristle head and the neck combine to form the motion conversion mechanism that converts rotary oscillation of the drive shaft into rotary oscillation of the bristles having a desired angular movement.

### BRIEF DESCRIPTION OF THE DRAWINGS

FIG. 1 is a sectional view of a prior art replacement brush head.

FIG. 2 is an exploded perspective view of a brush head according to one embodiment of the present invention.

FIG. 3A is a front view of a brush head.

FIG. 3B is a cross-sectional view along section A-A of the brush head in FIG. 3A;

FIG. 4 is a detailed view of the brush head.

FIG. 5 is a schematic top view representation of the brush head rotation.

FIG. 6A is a side view of the brush head.

FIG. 6B is a cross-sectional view along section A-A of FIG. 6A.

FIG. 7 is a cross-sectional view along section B-B of FIG. 6A.

FIG. 8 is a cross-sectional view along section B-B of FIG. 6A with a drive shaft.

FIG. 9 is a cross-sectional view along section B-B of FIG. 6A with the drive shaft.

FIG. 10 is a cross-sectional view along section B-B of FIG. 6A with the drive shaft.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DETAILED DESCRIPTION OF THE CURRENT EMBODIMENTS

### A. Prior Art

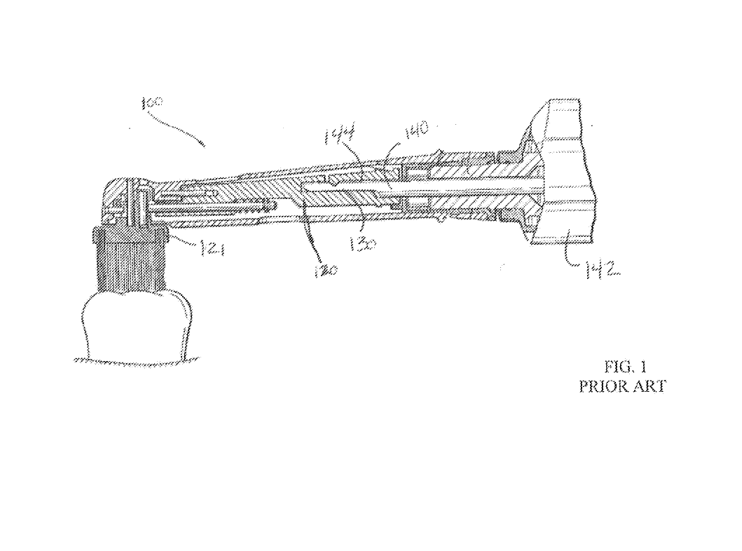

FIG. 1 is a sectional view of a prior art brush head 100 and drive unit 142. The brush head 100 is fitted on a drive shaft 140 extending from the drive unit 142. The drive unit 142 (which includes a motor), can be operated to drive the drive shaft 140 in a rotary oscillating motion (i.e., repeating rotation about a longitudinal axis throughout an angular range). The drive shaft 140 includes a D-shaped cross-section with a rounded section 144 and flat section 146. The plug-on shaft 120 of the brush head 100 is shaped to correspond to the D-shaped cross-section of the drive shaft 140 and has a flat zone 130 to engage the drive shaft 140 and transmit torque and rotary movement from the drive shaft 140 to the plug-on shaft 120. The power provided by the drive unit 142 is directly transferred to the plug-on shaft 120 and ultimately to the bristle carrier 121. In this example, the bristle carrier 121 is configured to rotate about an axis that is perpendicular to the axis of rotation of the drive shaft 140.

### B. Overview

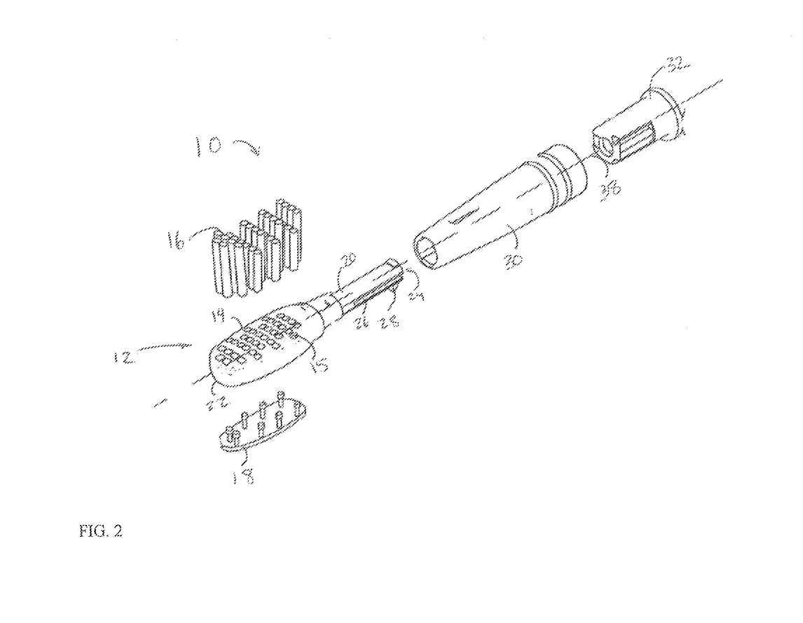

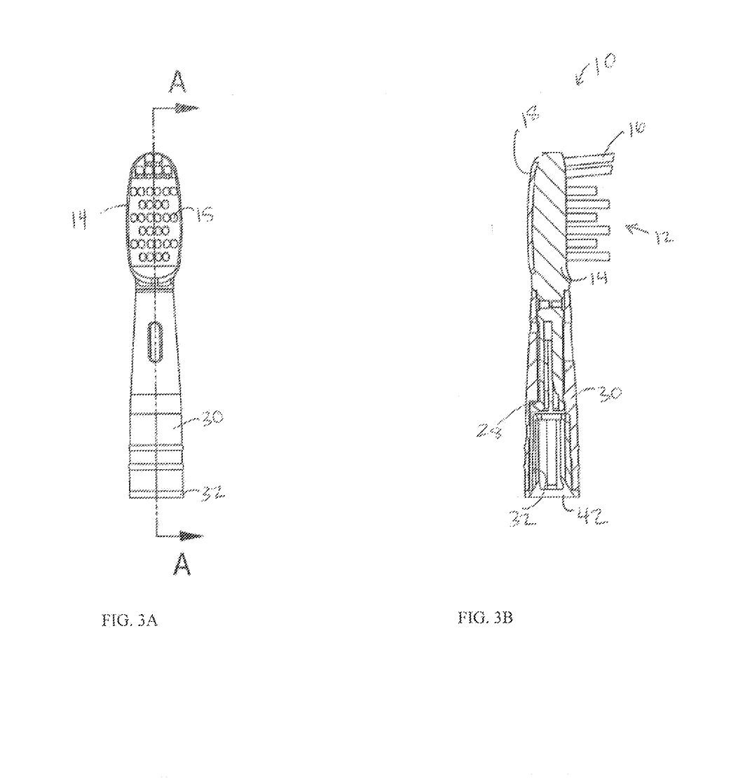

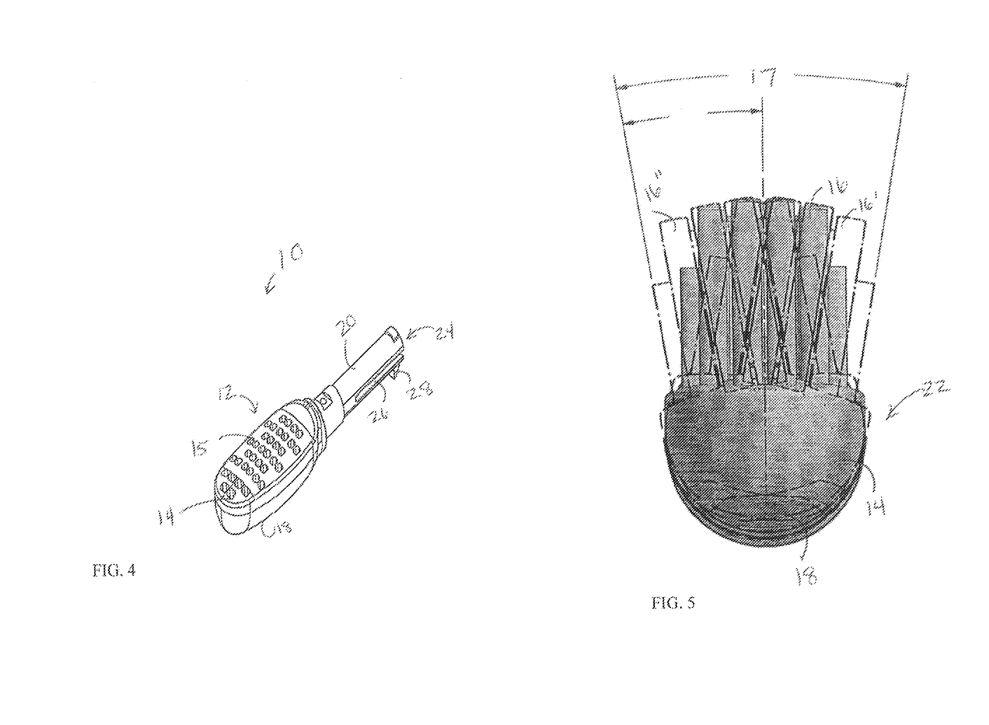

A replacement brush head for an electric toothbrush according to one embodiment of the present invention is shown in FIGS. 2-7 and generally designated 10. The replacement brush head 10 of FIGS. 2-7 generally includes a bristle head portion 12 and a hollow neck portion 30. One end of the bristle end portion extends into an end of the neck portion and is movable with respect to the neck portion. The replacement head 10 is designed to operate when fitted to a drive unit such as the drive unit 142 shown in FIG. 1. Unlike the prior art brush head, however, the brush head 10 of the present invention is configured such that the bristle head portion 12 is directly driven by the drive shaft 140 in rotary oscillation about an axis that is aligned with the longitudinal axis of the drive shaft 140. The neck portion 30 remains stationary with respect to the drive unit 142.

The brush head 10 of the illustrated embodiment may be secured to the drive unit 142 by friction fit of components of the brush head onto the drive unit 142 and the drive shaft 140. Alternatively, the brush head may be coupled to the drive unit by threading or otherwise connecting a portion of the brush head onto a portion of the drive unit. Although the brush head 10 is described in connection with the particular drive unit 142 and drive shaft 140 shown in FIG. 1, it should be understood that the motion conversion principles of the brush head 10 can be altered for use with other drive units and other types of drive shafts. As described in more detail below, the movable bristle portion of the brush head is designed to mate with the drive shaft 140 in such a way that the bristle portion does not rotate at a direct 1:1 ratio with the drive shaft.

### C. Structure

As shown, the replacement brush head 10 includes a neck 30, and a bristle head 12 with a first end 22 and second end 24. In the illustrated embodiment, the first end 22 forms a bristle base 14. The bristle base 14 includes a plurality of holes 15 to facilitate the seating of tufts of bristles 16 on the bristle base 14. Alternatively, the bristle base 14 may be configured to receive other cleaning elements, such as elastomeric cleaning elements. In the illustrated embodiment, an optional bristle head overmold 18 is affixed to the base 14 on a side opposite the bristles. The overmold may be made from the same material as the bristle head 12. This can provide opportunity to vary colors of the bristle head and/or more easily allow space for brand identity or other labeling. Alternatively, the overmold 18 may be formed from a material that is different from the bristle head 12. For instance, the bristle head 12 may be formed from a rigid plastic material and the overmold may be formed from a resilient elastomer that may function as a soft tissue cleanser. The size and shape of the bristle base 14, and the placement, orientation and type of bristles or cleaning elements may be varied from application to application.

As illustrated, the second end 24 of the bristle head 12 forms a brush shaft 20 that extends into the neck 30 and receives the drive shaft 140 extending from the drive unit. The brush shaft 20 may be elongated in a direction parallel to the longitudinal axis 38 of the brush head 10, with a generally cylindrical outer surface. In the illustrated embodiment, the brush shaft 20 is an integral extension of the bristle base 14 (and formed from a single piece with the bristle base); however, in another embodiment the brush shaft 20 may be an independently formed component of the bristle head 12.

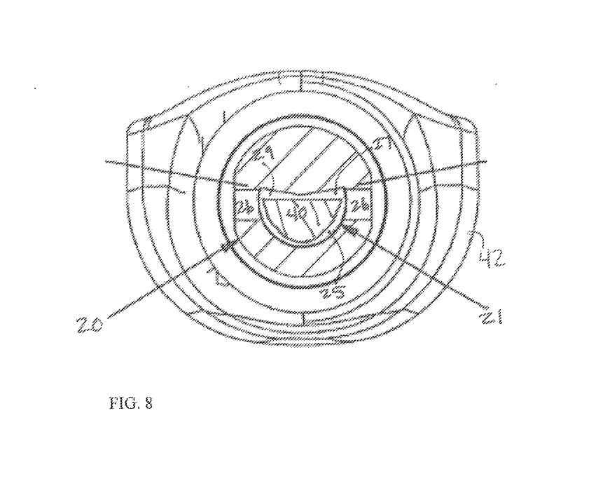

Referring now to FIGS. 7-10, the brush shaft 20 has a central bore 25 that forms a receptacle for the drive shaft 140 of the drive unit (FIGS. 8-10 refer to the drive shaft with reference numeral 40, which may be the same or substantially the same as the aforementioned rotary oscillating drive shaft 140). The central bore 25 has a cross-sectional shape that corresponds to the cross sectional shape of the drive shaft 40, but is modified to reduce the range of angular travel of the brush shaft 20 with respect to the range of angular travel of the drive shaft 40. In one embodiment, this is accomplished by forming a cross sectional shape for the central bore 25 that enables a range of free movement for the drive shaft 40 within the central bore 25. As a result, the brush shaft 20, and thus the bristle head 12 remains stationary throughout a portion of the range of angular motion of the drive shaft 40 and have a smaller range of angular motion than the drive shaft. In the illustrated embodiment, wherein the drive shaft 40 has a D-shape, the cross sectional shape of the central bore 25 is a “modified D-shape” with an upper edge 23 having a V-shape to create pie shaped wedges or gaps 27, 29 between the upper edge 23 and the flat portion of the corresponding D-shaped drive shaft 40 when the drive shaft is in a central position. More particularly, they are spaces between the upper edge 23 of the wall 21 and the drive shaft 40. In one embodiment, the point 19 of the upper edge 23 remains in contact with the drive shaft 40 and creates a frictional fit between the brush shaft 20 and the drive shaft 40. In one embodiment, the D-shape is modified such that the angle “A” in FIG. 7 is approximately 161 degrees. In another embodiment, the angle A may be modified as desired depending on the desired angular travel of the brush head 10.

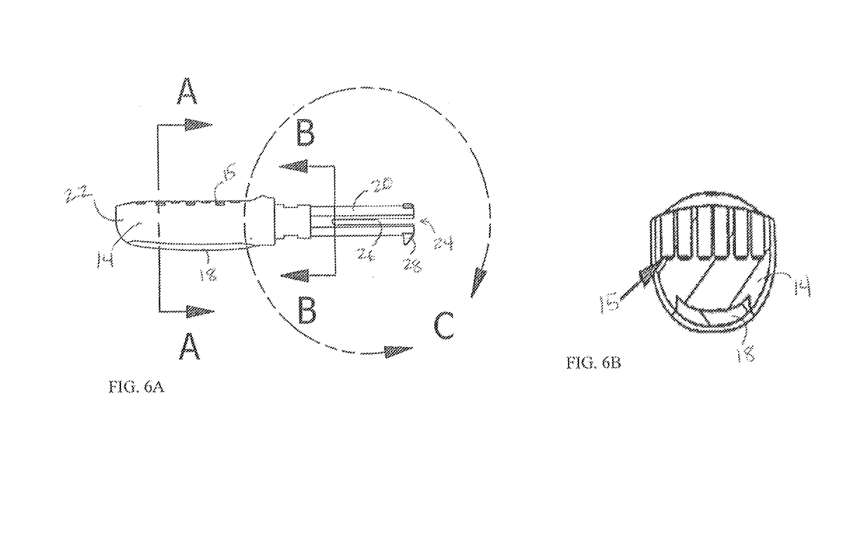

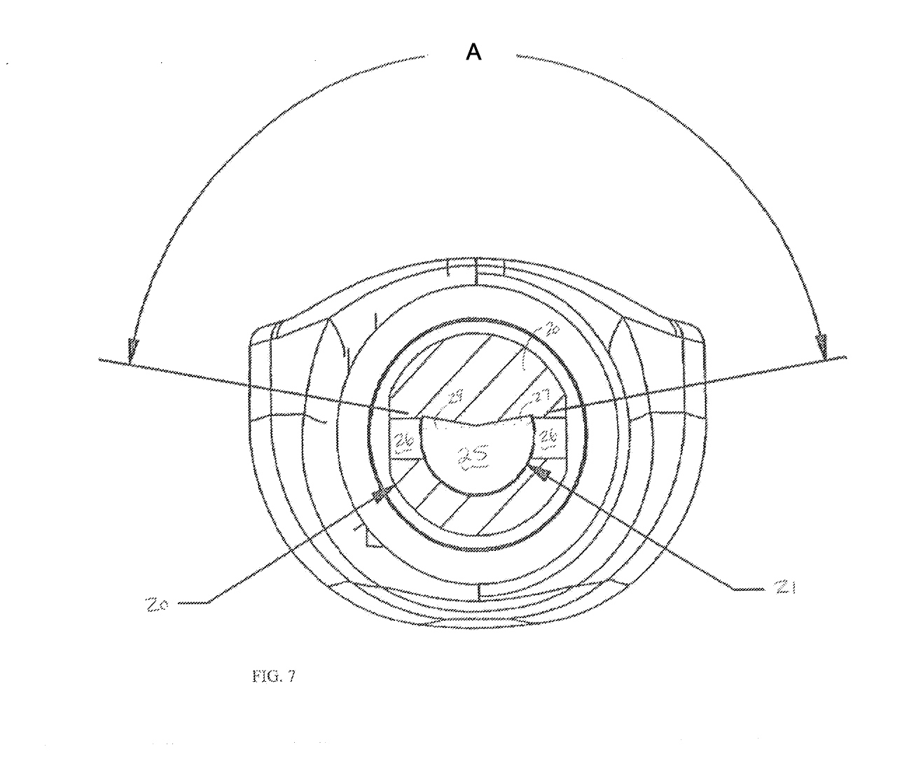

Referring now to FIG. 6A, the brush shaft 20 may include a channel 26 which runs parallel to the longitudinal axis 38 along one or both sides of the brush shaft 20 and divides the rear portion of the brush shaft 20 into an upper section and a lower section. The channel 26 may create a degree of flexibility within the brush shaft 20 between the upper and lower sections. The length and size of the channel 26 may be varied to control the amount of flexibility. In the illustrated embodiment, the channel 26 extends about 75% of the length of the brush shaft 20. In another embodiment, wherein a greater flexibility between the upper and lower sections is desired, the channel may extend greater than about 75% of the length of the brush shaft 20. In another embodiment, wherein less flexibility is desired, the channel may extend about 50% of the length of the brush shaft 20. A tab 28 may be disposed on or near the lower end 24 of the bristle head 12. The tab 28 extends outwardly from the brush shaft 20 in a direction generally perpendicular to the longitudinal length of the brush shaft 20.

The neck 30 is a hollow, generally cylindrical body with openings at opposite ends for receiving the drive unit 142 at one end and the brush shaft 20 at the opposite end. At least a portion of the brush shaft 20 extends through the neck 30. In the illustrated embodiment, the bristle base 14 abuts the neck 30 when the brush head 10 is completely assembled. In one embodiment, an insert 32 extends into the neck 30 at the end opposite the brush shaft 20. The insert may be configured to interfit with a portion of the drive unit 142 to retain the brush head 10 on the drive unit 142 and prevent rotation of the neck 30 with respect to the drive unit 142.

The bristle head 12, overmold 18, neck 30 and insert 32 may be manufactured from polymers or resins such as, but not limited to, being molds of polyoxymethylene (“POM”) such as that available under the Tradename DURACON® from Polyplastics and referred to as polyacetal or acetal resin. The bristles 16 may be made from a variety of materials including, but not limited to nylon and polybutylene terephthalate (“PBT”). The bristles 16 may also be made from natural materials having an appropriate stiffness. The bristles 16 may be attached to the bristle base 14 in a number of ways including being stapled inside the holes 15 or by other known methods. The bristles 16 may be cut to various trim profiles, as desired. The stiffness of the bristles 16 may be controlled depending upon the feel desired in the mouth.

### D. Operation

The brush head 10 is designed to operate in a manner that provides a user-comfortable range of motion of the bristles 16 by controlling the angle of travel 17 transferred from the drive shaft 40 to the brush shaft 20 as well as the torque of the brush shaft 20 when driven by the drive shaft 40.

FIG. 5 shows one example of the motion of a toothbrush head 10 according to the present invention. As shown in FIG. 5, the bristle base 14 and bristles 16 may be oriented in a neutral position in which the bristles 16 are shown in solid lines and may oscillate through an angular range of travel indicated by arc 17 between bristle positions 16′ and 16″, both shown in phantom lines.

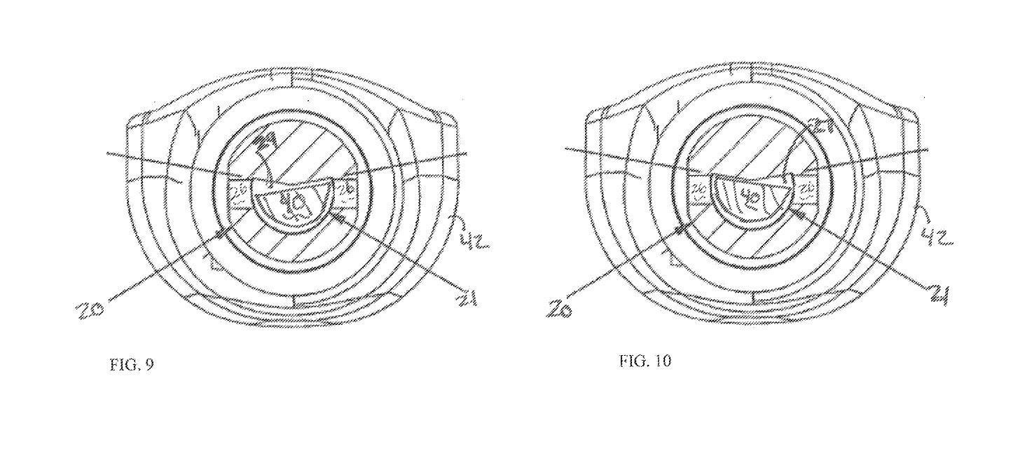

During operation, the drive shaft 40 oscillates about an axis over its factory set travel range of rotation. However, the bristle carrier 20 may oscillate over a smaller travel range 17. As shown in FIGS. 9 and 10, the drive shaft 40 may over-rotate relative to the brush shaft 20 due to the modified D-shaped or “Pac-Man” shaped cross-section the central bore 25 of the brush shaft 20. Specifically, FIG. 9 depicts the drive shaft 40 rotated to fill the pie-shaped wedge or gap 27 and to increase the area of pie-shaped wedge or gap 29. In FIG. 10, the drive shaft is rotated to fill the gap 29 and to increase the area of gap 27. During operation, the drive shaft 40 may oscillate between the position shown in FIG. 9 and the position shown in FIG. 10. The gaps 27, 29 create an incomplete oscillation of the carrier 20 relative to the drive shaft 40, thereby decreasing the amount of angular travel of the carrier 20 along the arc 17 relative to the amount of angular travel of the drive shaft 40. While the illustrated embodiments include a D-shaped drive shaft 40 and a modified D-shaped hollow portion 25 of the carrier 20, other shapes of the drive shaft and carrier hollow portion may produce the same or similar function and advantages. For example, a square or rectangular drive shaft may be provided and a hollow portion in the carrier may be a larger square or rectangle along one or more sides of the hollow portion to create a gap between the wall of the hollow portion and the drive shaft.

The increased angles beyond the D-shape of the hollow portion 25, or the gaps 27, 29 create slack, looseness, or float between the carrier 20 and the drive shaft 40. Further, during operation, the increased angle or gaps 27, 29 create a small delay of the carrier 20 rotation relative to the drive shaft 40 rotation. With a drive unit operating at about 5,000 RPM, the delay equates to a stall of about 15 ms per stroke on each side. A stall of this brevity is unperceivable, or at least unbothersome, by typical humans.

Advantages of the brush head shown and described herein include a reduced, compact angle of rotation 17 of the brush head 10. For example, if the input rotational angle as received from the drive shaft 40 is about 55-60° (27.5-30° from center), the output rotation of the carrier may be about 40° (20° from center). Additionally, due to the output angle and drive angle being of a ratio less than 1:1 without the use of gears or off-set shafts, the overall size of the brush head 10 may be reduced. The brush head 10 also allows for a reduced number of components required to produce similar results.

The angle of travel of the bristle head 12 may be further reduced, and the power transferred from the drive unit 42 to the bristle head 10 may also be reduced, by the flexibility created by the channels 26. The tab 28 on the second end 24 of the bristle head 12 may be held firm between the a portion of the neck 30 and the insert 32 to prevent rotation of the lower portion of the brush shaft 20. At the same time, the upper portion of the brush shaft 20, that is, the portion above the channels 26, may be allowed a degree of rotational movement. Thus, when the drive shaft 40 rotates as shown in FIGS. 8-10, the angular movement of the brush shaft 20 and brush head 10 is controlled by the flexibility created by the channels 26 and the movement of the upper section with respect to the fixed lower section. More particularly, referring to FIG. 9, further rotation of the drive shaft 40 will cause the channel 26 adjacent to the gap 29 to pinch closed as the upper portion rotates counter-clockwise with respect to the lower portion. Referring to FIG. 10, further rotation of the drive shaft 40 in the other direction will cause the channel 26 adjacent to the gap 27 to pinch closed as the upper portion rotates clockwise with respect to the lower portion. The length and depth of channel(s) 26 may be varied to provide increased or decreased flexibility of the upper section with respect to the lower section and thus increased movement of the bristle head 12. The amount of flex allowed by the channel 26 configuration, coupled with the amount of float provided by the modified central bore 25 may reduce the range of angular travel as well as the power transferred from the drive unit 142 through the drive shaft 40 to the brush head 10.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Additionally, any of the features from one embodiment may be used in another embodiment. Any reference to claim elements in the singular, for example, using the articles “a,” “an,” “the” or “said,” is not to be construed as limiting the element to the singular.

1. A replacement head for a toothbrush drive, the toothbrush drive including a rotary oscillating drive shaft having a cross-section with a size and shape, the replacement head comprising:
a bristle head having an upper surface including a plurality of cleaning elements, a first longitudinal end, and a second longitudinal end opposite the first longitudinal end;
a brush shaft extending from the first longitudinal end of the bristle head, the brush shaft defining a central bore; and
wherein the central bore has an upper surface, and wherein the central bore has a cross-section that is sized and shaped to provide a gap between the upper surface of central bore and at least a portion of the drive shaft, and
wherein, upon rotary oscillation of the drive shaft, the brush shaft has intermittent stationary periods during the movement of the drive shaft, the intermittent stationary periods defined by the gap between the central bore and the drive shaft.

2. The replacement head of claim 1 wherein the drive shaft cross-section is D-shaped including a substantially flat surface, and the central bore cross section is provided with a modified D-shape wherein the upper surface of the central bore is angled away from the substantially flat surface of the drive shaft to create the gap between the upper surface of the central bore and the at least a portion of the drive shaft.

3. The replacement head of claim 2 wherein the upper surface of the central bore includes two of the angled surfaces that converge to a point, wherein the point is aligned generally along the longitudinal axis of the replacement head.

4. The replacement head of claim 3 wherein the point abuts the flat surface of the drive shaft throughout substantially all of the range of movement of the drive shaft.

5. The replacement head of claim 4 wherein the range of angular movement of the brush shaft is between about 15 and 25 degrees less than the range of angular movement of the drive shaft for each complete oscillation of the drive shaft.

6. The replacement head of claim 1 further comprising a channel in the brush shaft parallel to a longitudinal axis of the brush head.

7. The replacement head of claim 6 wherein the channel extends completely laterally through the brush shaft.

8. The replacement head of claim 7 wherein the channel extends longitudinally into the brush shaft from an end of the brush shaft opposite the bristle head.

9. The replacement head of claim 8 including a neck at least partially surrounding a portion of the brush shaft, the neck connected to the drive unit with at least a portion of the neck being stationary with respect to the drive unit, wherein a portion of the brush shaft is affixed to the stationary portion of the neck, the channel enabling a degree of flexibility in the brush shaft such that the brush shaft flexes along the channel upon rotation of the drive shaft.

10. The replacement head of claim 9 wherein the brush shaft defines a length, and wherein the channel extends along at least about 50% of the brush shaft length.

11. The replacement head of claim 10 wherein the channel extends along at least about 75% of the brush shaft length.

12. The replacement head of claim 11 further comprising:
a tab extending from the brush shaft, the tab extending into a portion of the neck to secure the tab to the portion of the neck.

13. The replacement head of claim 12 including an insert within the neck, the tab cooperating with the insert to secure the tab in the neck.
